(19) United States
(12) Patent Application Publication
(10) Pub. No.: US 2008/0252553 A1
(43) Pub. Date: Oct. 16, 2008

(54) Antenna Mounting Foot and Method of Manufacture

(75) Inventors: Max Leadley-Brown, Edinburgh (GB); Mike Murray, East Lothian (GB); Mike Jefferson, Fife (GB)

Correspondence Address: BABCOCK IP, PLLC, P.O.BOX 488, BRIDGMAN, MI, 49106, US

(73) Assignee: ANDREW CORPORATION, Westchester, IL (US)

(21) Appl. No.: 11/735,406

(22) Filed: Apr. 13, 2007

(51) Int. Cl. H01Q 1/12

(52) U.S. Cl. 343/878

(57) ABSTRACT

An antenna mounting foot, formed from a unitary blank with a central portion having a mounting surface and a support surface. The mounting surface and the support surface are angled with respect to each other forming a triangular protrusion away from a planar base surface of complementary peripheral portions of the unitary blank having a pair of ends on each side that overlap one another. The mounting surface provided with a coupling hole and the support surface having an access hole.

### BACKGROUND

To maintain the desired signal alignment, an antenna such as a reflector antenna should be rigidly mounted. Antennas are typically mounted to the roofs and or sides of structures. A mounting foot is used to directly attach the antenna to the desired mounting surface, for example via screws or lag bolts, the remainder of the antenna mount is coupled to the mounting foot. To universalize antenna mounts for a wide range of mounting surface angles, the connection between the mounting feet and the further struts and or braces of the antenna mount is fixable at a range of different angles.

The antenna mounting feet must securely support the entire antenna mass and also withstand any expected environmental factors such as wind shear and or ice loading.

Prior antenna mounting feet have been formed from, for example, planar mounting plates with a domed area stamped in a central area, allowing a carriage bolt to be positioned in the domed area projecting normal to the mounting plate for connection to the antenna mount. The normal to the mounting plate connection requires further hardware to create a variable mounting angle functionality.

Another simplified mounting foot solution is an L shaped bracket. Although this type of mounting foot is simple to manufacture, to have adequate strength, the L shaped bracket requires application of a heavy gauge metal material, significantly increasing the materials costs and overall weight of the antenna mount.

The increasing competition for reflector antennas and associated mounting assemblies adapted for both industrial and high volume consumer applications such as data, VSAT, satellite tv and or internet communications has focused attention on cost reductions resulting from increased materials, manufacturing and service efficiencies. Further, reductions in required assembly operations and the total number of discrete parts are desired.

Therefore, it is an object of the invention to provide an apparatus that overcomes deficiencies in the prior art.

### BRIEF DESCRIPTION OF THE DRAWINGS

The accompanying drawings, which are incorporated in and constitute a part of this specification, illustrate an exemplary embodiment of the invention and, together with the general and detailed descriptions of the invention appearing herein, serve to explain the principles of the invention.

FIG. 1 is an elevated isometric view of an antenna mounting foot according to the invention.

FIG. 2 is a schematic top view of a planar manufacturing blank for an antenna mounting foot according to the invention.

FIG. 3 is a schematic top view of FIG. 1.

FIG. 4 is a schematic side view of FIG. 1.

FIG. 5 is a schematic cross sectional view of line A-A of FIG. 4.

### DETAILED DESCRIPTION

A mounting foot according to the invention may be used for example as part of an antenna mount with a main support that is stabilized by two adjustable length struts each attached to a desired mounting structure such as the wall or roof by one of the antenna mounting feet.

Because the height and or angle at which the adjustable length struts are attached to the mounting structure may vary, the antenna mount is mountable upon a range of surfaces upon which an angle between the antenna mounting foot and the adjustable length struts is variable.

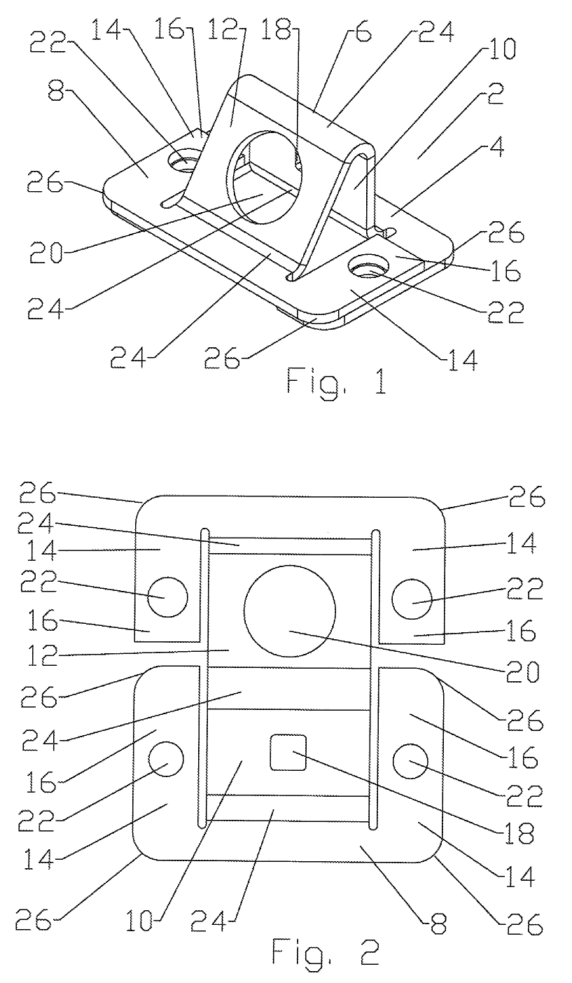

As shown in the various views of FIGS. 1 and 3-5, an antenna mounting foot 2 according to the invention is a unitary blank 4, as shown in FIG. 2, formed with a triangular protrusion 6 extending from a planar base surface 8. The triangular protrusion 6 has a mounting surface 1 0 and a support surface 12 angled with respect to each other. Preferably, the mounting surface 1 0 is angled to be normal with respect to the planar base surface 8 comprised of complementary peripheral portion(s) 14 having a pair of end(s) 16 on each side that overlap one another. The mounting surface 10 is provided with a coupling hole 18 and the support surface 12 has an access hole 20. The coupling hole 18 may be formed as a square to rotationally interlock a fastener such as a carriage bolt, as best shown in FIG. 5, the access hole 20 is sized to allow passage of the selected fastener's head, for ease of final antenna mount assembly.

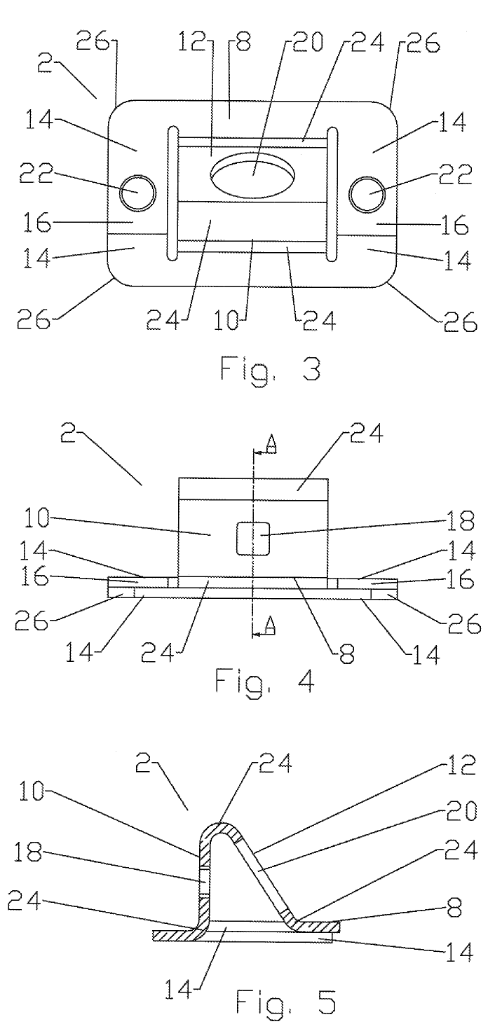

As best shown in FIG. 3, each pair of overlapping end(s) 16 has a mounting hole 22 therethrough, the mounting hole(s) 22 coaxial to accept a single mounting fastener such as a screw or lag bolt. When installed, besides attaching the mounting foot 2 to the desired mounting surface, the mounting fastener(s) prevent separation of the overlapping end(s) 16, greatly improving the strength of the antenna mounting foot 2, overall.

The antenna mounting foot 2 may be formed in a single step stamping operation using a two part tool to simultaneously form all of the necessary bends. A flat blank from stock plate or roll material of generally constant thickness, for example as shown in FIG. 3, is pre-cut or stamped with each of the desired holes and slots. The thickness of the stock material may be selected according to the anticipated overall antenna mass and expected environmental loads, such as wind and or ice. Allowance is made in the flat blank configuration for material sections that will become rounded transition(s) 24 between the various surfaces. Because each of these rounded transitions have a longitudinal axis parallel to one another, during the stamping operation, the drawing of the pair of end(s) 16 on each side to overlap one another occurs simultaneously during the stamping step.

The end(s) 16 which finally end up at the periphery of the planar base surface 8 may be provided with rounded edge(s) 26 to provide with an antenna mounting foot 2 without sharp edges, but that requires no secondary finishing steps. For corrosion resistance, a metal material with corrosion resistant properties such as stainless steel and or galvanized steel may be used and or in the alternative a final corrosion resistant coating, plating or paint may be applied.

The present invention provides an antenna mounting foot 2 with improved strength, weight and cost characteristics. The antenna mounting foot may be precision manufactured in a simplified blank forming and stamping process from commonly available metal stock material.

Table of Parts

| | |
|---|---|
| 2 | mounting foot |
| 4 | unitary blank |
| 6 | triangular protrusion |
| 8 | planar base surface |
| 10 | mounting surface |
| 12 | support surface |
| 14 | peripheral portion |
| 16 | end |
| 18 | coupling hole |
| 20 | access hole |
| 22 | mounting hole |
| 24 | rounded transition |
| 26 | rounded edge |

Where in the foregoing description reference has been made to ratios, integers, components or modules having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

We claim:

1. An antenna mounting foot, comprising:
a unitary blank with a central portion having a mounting surface and a support surface;
the mounting surface and the support surface angled with respect to each other forming a triangular protrusion away from a planar base surface of complementary peripheral portions of the unitary blank; the peripheral portions having a pair of ends on each side that overlap one another; the mounting surface provided with a coupling hole and the support surface having an access hole.

2. The antenna mounting foot of claim 1, wherein each of the overlapping ends has a mounting hole therethrough.

3. The antenna mounting foot of claim 1, wherein the access hole is dimensioned to pass a bolt head.

4. The antenna mounting foot of claim 1, wherein the coupling hole is square.

5. The antenna mounting foot of claim 1, wherein each of four corners of the planar base surface have rounded edges.

6. The antenna mounting foot of claim 1, wherein a material thickness of the unitary blank is generally constant.

7. The antenna mounting foot of claim 1, wherein the mounting surface is normal to the base surface.

8. The antenna mounting foot of claim 1, wherein a transition between the base surface and the mounting surface, between the mounting surface and the support surface and between the support surface and the base surface is rounded.

9. The antenna mounting foot of claim 8 wherein each of the transition(s) have a parallel longitudinal axis.

10. A method of manufacturing an antenna mounting foot, comprising the steps of:
forming a unitary blank from a planar metal material with a central portion having a mounting surface and a support surface;
bending the unitary blank to angle the mounting surface and the support surface with respect to each other, forming a triangular protrusion away from a planar base surface of complementary peripheral portions of the flat blank having a pair of ends on each side that overlap one another.

11. The method of claim 10, wherein the unitary blank is formed by metal stamping.

12. The method of claim 10, wherein the unitary blank is stainless steel.

13. The method of claim 10, wherein the unitary blank is formed with a coupling hole in the mounting surface and an access hole in the support surface.

14. The method of claim 10, wherein the bending of the unitary blank is via a single impact tool.

15. The method of claim 10, wherein the bending positions the mounting surface normal to the planar base surface.

16. The method of claim 10, wherein the bending positions mounting holes, formed in the pair of ends on each side, coaxial with one another.

17. The method of claim 10, wherein the bending forms rounded transitions between the base surface and the mounting surface, between the mounting surface and the support surface and between the support surface and the base surface.

18. The method of claim 17, wherein each of the rounded transitions have a parallel longitudinal axis.
